(19) United States
(12) Patent Application Publication
(10) Pub. No.: US 2009/0238234 A1
(43) Pub. Date: Sep. 24, 2009

(54) METHOD FOR OPERATING A MELT-METALLURGIC FURNACE, AND FURNACE

(76) Inventors: Manfred Schubert, Oberhausen (DE); Klaus Krueger, Hamburg (DE); Markus Dorndorf, Hamburg (DE)

Correspondence Address: K.F. ROSS P.C., 5683 RIVERDALE AVENUE, SUITE 203 BOX 900, BRONX, NY, 10471-0900, US

(21) Appl. No.: 12/441,409

(22) PCT Filed: Sep. 13, 2007
(86) PCT No.: PCT/EP2007/007982

§ 371 Date: Mar. 16, 2009

(30) Foreign Application Priority Data
Sep. 18, 2006 (DE) 10 2006 044 351.9
Sep. 28, 2006 (DE) 10 2006 046 274.2
Sep. 3, 2007 (DE) 10 2007 041 632.8

(51) Int. Cl. H05B 7/148; G05B 11/01; G05B 13/02; G05D 7/00; G05D 23/00

(52) U.S. Cl. 373/104; 700/20; 700/50; 700/282; 700/300

(57) ABSTRACT

The invention relates to a method for operating a melt-metallurgic furnace (2), particularly an arc furnace, during the operation of which a number of operating parameters are maintained within predetermined thresholds, wherein for this purpose a control or regulating device (1) is utilized. In order to obtain greater efficiency of the furnace, the invention provides that the control or regulating device (1) has a conventional control or regulating device (9) and a fuzzy regulating device (10), which each feed their correcting variables to a mediator (11), wherein the mediator (11) calculates the actuating signal used according to a predetermined weighting factor (F) from the correcting variable coming from the conventional control or regulating device (9) and from the fuzzy regulating device (10). The invention further relates to a melt-metallurgic furnace, particularly an arc furnace.

The invention relates to a method of operating a melt-metallurgic furnace, in particular an arc furnace, during the operation of which a number of operating parameters are maintained between predetermined limits that may vary with time, for this purpose a controller working with or without feedback being used. Furthermore, the invention relates to a melt-metallurgic furnace, in particular an arc furnace.

In a melt-metallurgic furnace of the type mentioned scrap metal is melted by means of electric energy. This process is part of steelmaking. A number of arcs are usually present that burn between the electrode tip and the melting charge and provide the heat necessary for the melting process in the form of thermal energy.

For efficient and energy-saving steel production substance flows and energy flows must be optimally adjusted control systems are known for this purpose that control with or without feedback the furnaces mentioned above. Examples of this are described in WO 2002/028146, in DE 197 11 453, in EP 0 036 122, in DE 44 15 727, in WO 2002/063927, and in WO 1999/023264.

To get efficient furnace operation with regard to energy consumption and productivity, the following correcting variables can be predetermined in the melt course in a process-oriented manner:

Current strength of each arc and the outer-conductor or
DC voltage,
Choke reactance,
Natural gas and oxygen volume flow of each burner,
Volume flow of the oxygen fed to the afterburner,
Oxygen volume flow and fine coal volumetric flow of each injector for foaming slag generation,
Supply rate of the directly reduced iron,
Supply rate of the continually added scrap and
Supply rate of the liquid pig iron.

The predetermination of the values is usually carried out nowadays in the form of controls depending on the time from the start of melting or the energy provided. Since this defines the process only to a limited extent, manual intervention or generally manual settings are a regular occurrence.

Furthermore, there are approaches to control individual cited control variables depending on the process state. The description of the process state is thereby carried out, i.a. by various cooling water temperatures, the acoustic output of the furnace, the exhaust composition and various electrical values, such as, for example, the current harmonic distortion. The associated controllers are structured in the form of classic controllers, as characteristic map controllers or as neural networks. The typical feature of existing controllers is that the respective individual control variable is viewed in isolation. The user interfaces (HMI) are consequently embodied in a specific and non-uniform manner. In addition, adjustment of the parameters of known control approaches requires in-depth control engineering known how. This makes the operational optimization very difficult. However, in view of longer-term process fluctuations, such as result, for example, from the scrap metal quality or the production range, a more efficient operation requires precisely this optimization.

With known controllers it is therefore a disadvantage that a low transparency of the unit is given. Previously work has preferably been carried out in manual or only semiautomated operation. There is thus only a controlled use of resources (operating supplies and time) and so far no comprehensive view of the smelting process.

Furthermore, the controls have hitherto existed only for subsystems, e.g. for the burner control and for the foamed slag control.

There is thus no optimal use of energy. Furthermore, a relatively high administrative expenditure is necessary for consistently high productivity of the system.

Finally, due to breakdowns of the operations and downtimes that result therefrom, there is an increased risk that necessary manual interventions are not carried out in time or are carried out in an unsuitable manner.

The object of the invention is therefore to provide a method of operating a melt-metallurgic furnace, in particular an arc furnace, and a furnace with which the cited disadvantages are avoided or at least reduced. Improved efficiency is to be achieved thereby, i.e. a more economical use of the resources and an optimally low process time. A process-control system for the overall coverage and control of the smelting process of an electric-arc furnace is thus to be provided.

This object is obtained the invention in terms of process in that the controller has a conventional controller working with or without feedback and a fuzzy-logic controller that feed respective correcting variables to at least one mediator that calculates an actuating signal using a predetermined weighting factor from the correcting variables coming from the conventional controller and from the fuzzy-logic controller.

The mediator can basically link both the correcting variable of a control (Level 1) system and a conventional controller as well as that of a control and a fuzzy-logic controller.

All of the individual components used are thereby structured in the same way (with uniform HMI).

The controlled operating parameter can be the intensity of a burner with which material is heated in the furnace.

It can also be the input power of an electric arc with which material is heated in the furnace.

It can also be the reactance of a feed line including choke for an electric arc with which material is heated in the furnace.

It can also be the intensity of an afterburner with which material is heated in the furnace.

It can also be a parameter that correlates to the quantity of foamed slag that is located in the furnace.

It can also be the quantity of a gas supplied to a heating element of the furnace. The gas can preferably be oxygen or natural gas.

The controlled operating parameter can also be the quantity of the added iron.

A separate mediator can be assigned to each controlled operating parameter.

Preferably at least two, preferably all of the controlled operating parameters are processed in a uniformly combined control system.

The melt-metallurgic furnace, in particular arc furnace, during the operation of which a number of operating parameters are maintained between predetermined limits by means of a controller, is characterized according to the invention in that the controller has a conventional controller and a fuzzy-logic controller that are connected to at least one mediator that calculates an actuating signal according to a predetermined weighting factor from the correcting variables coming from the conventional controller and from the fuzzy-logic controller.

Essential features of the proposed solution therefore lie in providing the use of fuzzy logic in the control algorithms used and carrying out a linking of conventional and fuzzy-based control engineering by mediators. It is thereby preferred to provide a modular software architecture with an individually configurable controller structure.

The comprehensive process control system developed for this, which observes all substance flows and energy flows, calculates from the actual condition of the furnace and the predetermined control parameters the initial quantities in preferably seven special control algorithms: “Burner Control,” “Power Control,” “Reactor Control, “DRI Control,” “Afterburner Control,” “Foaming Slag Control, “Oxygen Control” (e.g., jet). These correcting variables are returned to the system again.

The control algorithms are thereby based on a combination of conventional controller and fuzzy-logic controller that can be linked to one another by the cited mediators and that are freely selectable and configurable in an algorithm-specific manner. An electric-arc furnace can thus be controlled or controlled in an optimal manner.

The mediator establishes the ratio (weighting) between conventional controller and fuzzy-logic controller. It has an excluding effect with the setting 1 (no fuzzy control, only conventional control) or with the setting 0 (no conventional control, only fuzzy control).

A modular, flexible, object-oriented and dynamic software architecture permits easy adjustment of each furnace configuration by adjustment of the furnace and control parameters (furnace configuration and control data).

The expandable controller combination can comprise up to seven control algorithms that can be connected to and disconnected from the process, namely

Power Control

Burner Control

Reactor Control

Afterburner Control

Foaming Slag Control

Oxygen Control and

DRI Control

that are initialized by a central controller. A general fuzzy controller can be coupled to each controller specifically by a mediator.

Preferably, autonomous control and control of each individual furnace element (natural gas/oxygen burner, oxygen injectors, afterburner oxygen injectors, carbon injectors, DRI injectors) is provided, since specific control parameters can be defined for each furnace element. Furthermore, each individual furnace element (e.g. one of the burners) can be connected or disconnected by itself.

Central sequence control of the software is carried out by a process manager. The process manager initializes and monitors the subsystems and functions of the process control system.

A flexible, expandable and process-independent connection of display windows (views) and log files (stores) can be carried out by observer technology.

An intuitive and simple structure of the display windows for the process data display of the FEOS (Furnace Energy Optimizing System) and the FEOS control data manager for the parametrization of the furnace and the control temperature is given.

The configuration of control parameters and the furnace configuration can be carried out by means of an independent program and the storage of the configuration as an XML file.

The process control preferably works with a cycle time smaller than or equal to 1 second.

Continuous process monitoring and a defined reaction to corresponding process conditions are thus given by the analysis of thermal vessel load, acoustic emission, power fluctuations, current electric variables and exhaust emission.

The process control system is based on a modern object-oriented software architecture, is structured in a modular manner and offers the possibility of connecting or disconnecting subsystems or subcontrollers to the process and is easily expandable due to the flexible structure.

The system has a monitoring character and can be combined with existing Level 1 systems. It integrates and processes data from new technologies for exhaust analysis and sound measurement.

The comprehensive approach and the consideration of all substance flows and energy flows advantageously results in a program that unites all previous control concepts in one system. It integrates the specifications from the Level 1 system of the operator in the master display and the process engineer.

The system is designed according to the latest methods of control engineering and software development (modularity, expandability, uncoupling of visualization and data processing) and programs with the latest software (C++), which underlines the system's sustainable character.

The autonomous architecture of the system renders possible use in any steel works for three-phase current arc furnaces. It is connected to the steel works by an SPS, a software-side adjustment is not necessary. This is carried out exclusively by the parameter configuration for the furnace elements and the control parameters.

The proposed system offers on a platform an automatic adjustment of the correcting variables to the current process condition, renders possible an optimized use of electric power, chemical additives (such as fine coal and oxygen) and thus guarantees a higher transparency of the smelting process. This leads to a relief of pressure on the operating personnel, to a reduction of operational breakdowns and downtime and to the avoidance of the risk of accidents.

Through the connection with existing Level 1 systems and the simple adjustability to new system configurations, administrative expenditure is reduced at the same time.

This results in a reduction of process costs and a time minimization per t steel, which means an advantage in terms of cost and thus a competitive advantage. A consistently high productivity with lower energy consumption can thus be achieved.

Embodiments of the invention are shown in the drawing. Therein:

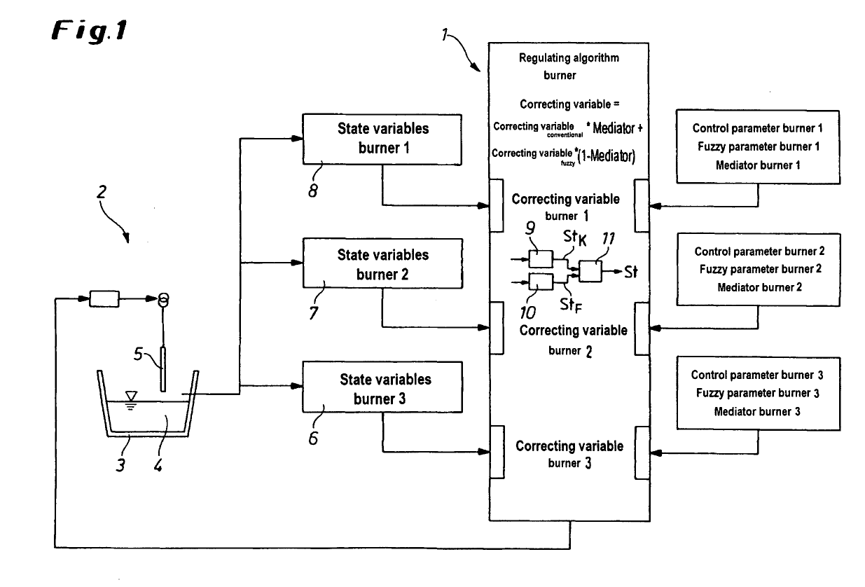

FIG. 1 is a diagram of a control system of an electric-arc furnace;

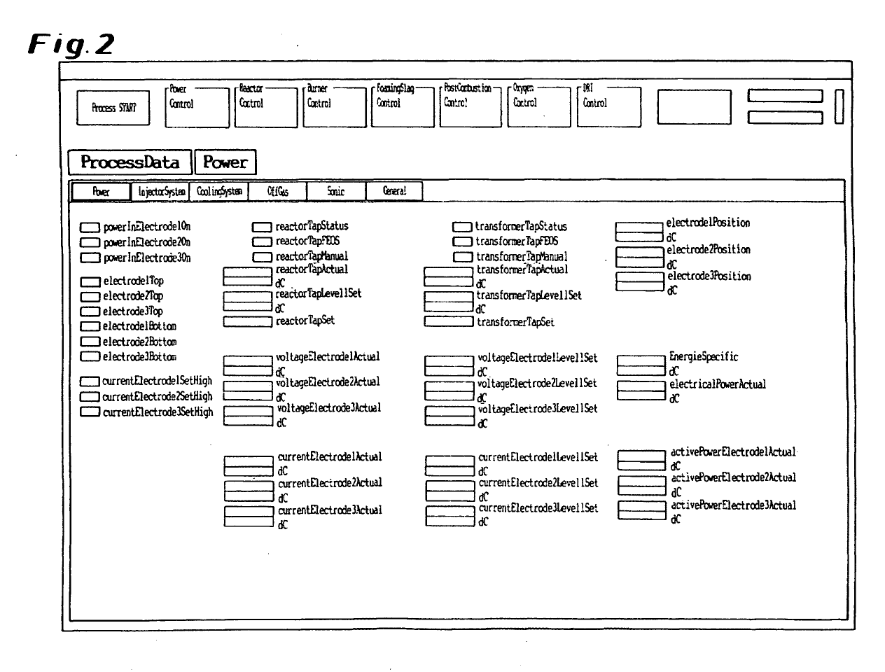

FIG. 2 is a screen shot of the screen of the control system for controlling the power;

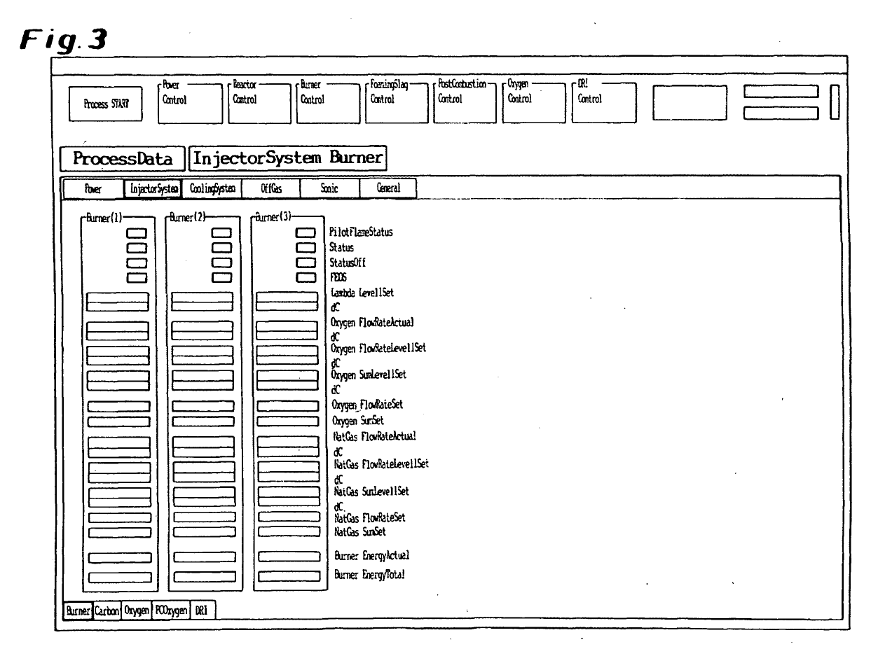

FIG. 3 is a screen shot of the screen of the control system for controlling the burner;

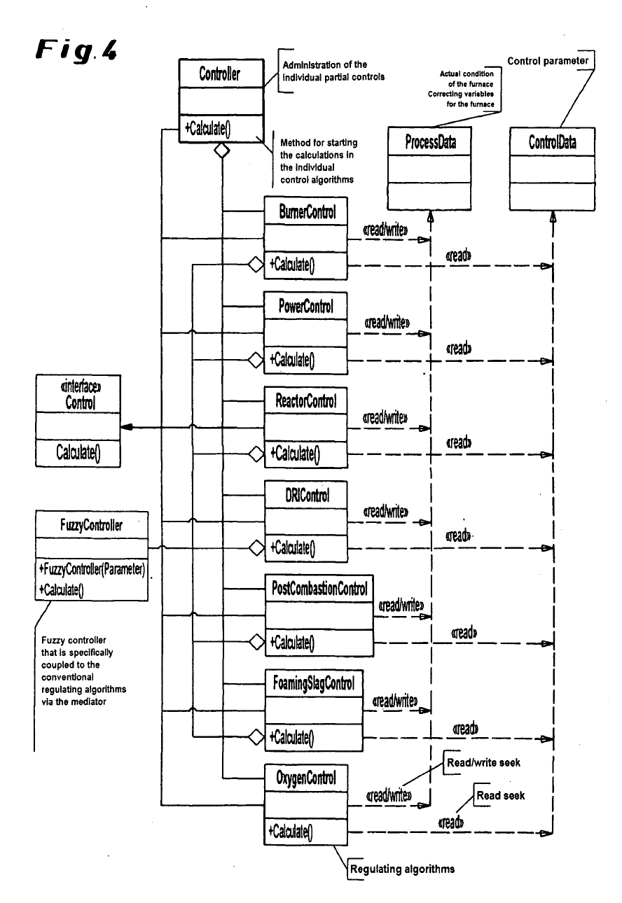

FIG. 4 is a diagram of a controller architecture from which a total of seven controlled operating parameters can be seen;

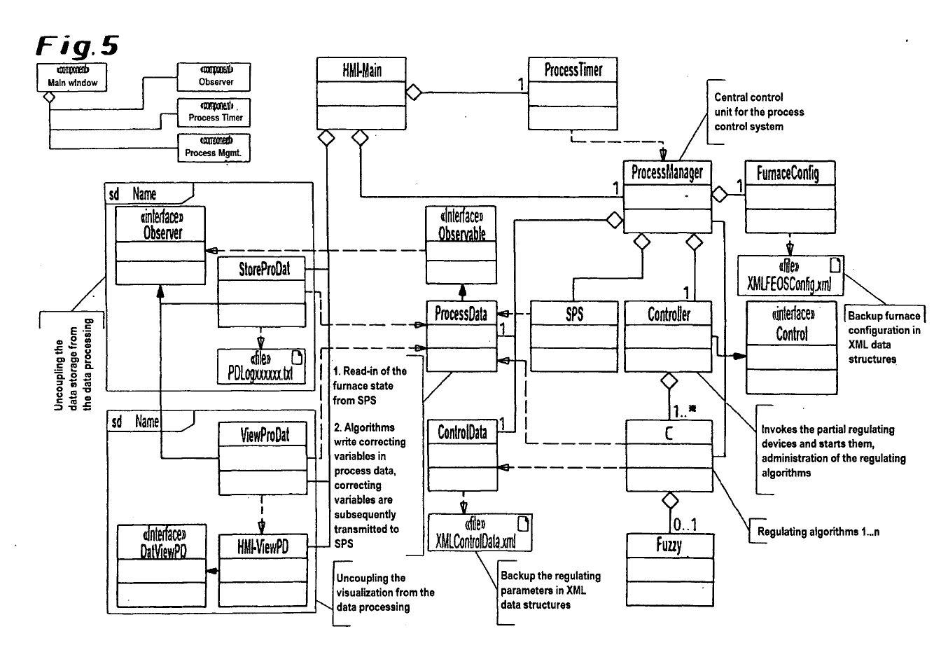

FIG. 5 is a diagram of a controller architecture or software architecture;

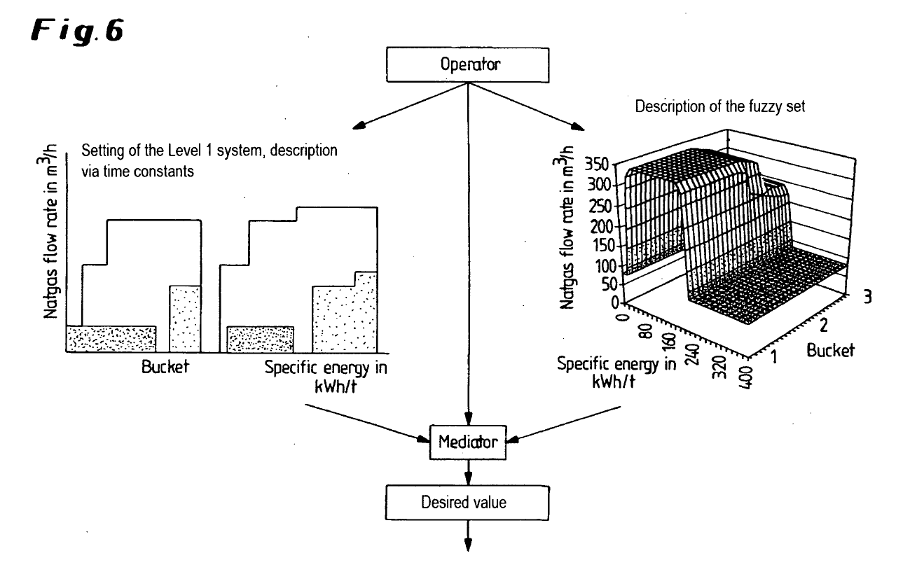

FIG. 6 is a diagram of the functional description of the processes taking place in the furnace and the definition of fuzzy elements; and

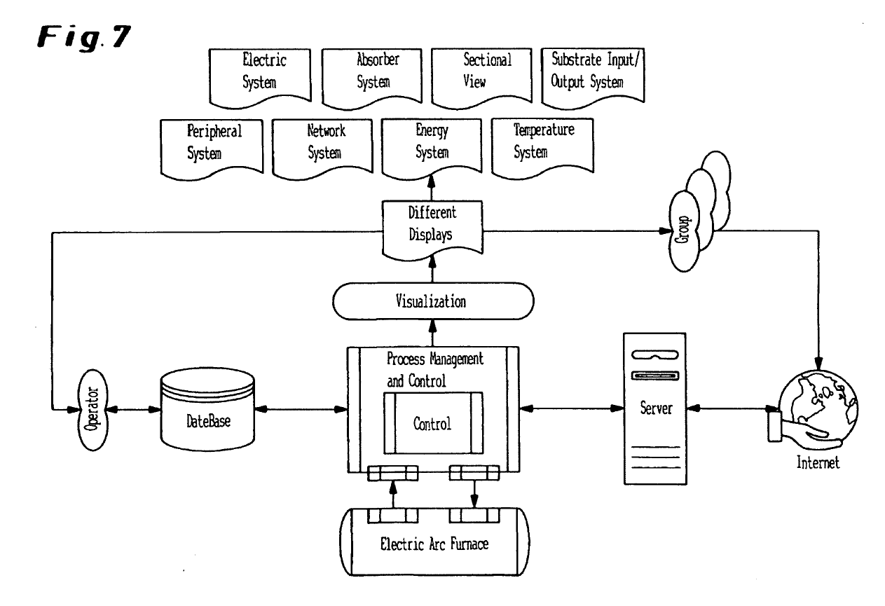

FIG. 7 is a diagram showing the incorporation of the control system of the furnace into its surroundings.

FIG. 1 is diagram of the structure of a control system 1 for controlling an electric-arc furnace 2. Metal 4 to be melted is in a vessel 3. Electric power is supplied to the furnace by an electrode 5 and the metal is thus melted.

The furnace 2 serves to recover steel from steel scrap, wherein in addition to scrap, directly reduced iron and pig iron can be used as well. Since 35% of the world's steel is made this way, the furnace has a considerable economic importance.

The charge is smelted basically by an alternating- or direct-current arc. Typically this is carried out as a batch process. It is also possible to add liquid pig iron to the furnace before or after charging of the scrap or to continuously feed the scrap or directly reduced iron. The smelting power is determined by the current strength and the arc voltage. In principle the current strength can be freely selected within system-specific and process-specific limits, like the arc voltage of the direct current electric-arc furnace. In the case of three-phase electric-arc furnace, the arc voltage can be predetermined in stages that are determined by the transformer layout. The general object is to select parameters such that a high productivity and a low energy consumption are achieved. This optimum is system-specific and depends substantially on the current process condition.

Another electric parameter that is dynamically variable as the process is carried out is given by the series reactance, at least as far as this is controlled by a choke coil switchable under load or steplessly variable. High reactance leads to calming of the furnace operation, low reactance leads to a high available arc voltage.

In addition to the electric power applied by the arcs, numerous auxiliary powers are used. These play a substantial role with a modern electric-arc furnace.

First of all natural-gas oxygen burners (or in general also fuel/oxygen burners) should be mentioned here. These burners are attached on the rim of the furnace vessel, during the first part of the process they assist the melting down of the scrap aggregate. In general at this point the burners represent a very efficient way of utilizing power. The optimal application duration and performance are thereby determined by the consistency of the scrap aggregate in the burner region. The associated optimum is thus system-specific as well as dependent on the actual charge.

Another energy source is the atmosphere inside the furnace vessel. This can contain considerable proportions of carbon monoxide, methane and hydrogen. The chemical energy contained therein can be used by the injection of oxygen. On the one hand the oxygen quantity can be controlled by the stoichiometry of the above-described burners, on the other hand separate, so-called afterburner oxygen injectors are available in the upper area of the furnace. The optimal operating point of these injectors depends on the composition of the furnace atmosphere and the thermal condition of the furnace vessel, in particular the vessel cover and the venting system. It should be noted thereby that the composition of the furnace atmosphere can change substantially within a short time.

The injection of oxygen and fine coal into the steel bath should be mentioned as another important factor of energy input. This is carried out by lance manipulators and/or ultrasonic injectors. In addition to metallurgic aspects, the feed of fine coal and oxygen in particular to produce foaming slag, i.e. slag floating on the steel bath, is foamed by resulting carbon monoxide bubbles to ten to twenty times of its original volume. A good enveloping of the arcs and thus a good energy transfer to the melt is thus also ensured with a liquid steel bath. In addition to blowing in a suitable quantity of oxygen and fine coal, the slag composition and its viscosity play an important role in the production of foaming slag.

As the last substance flow of interest in terms of energy, the addition of directly reduced iron should be mentioned. It lends itself to being added continuously to a liquid steel bath. The optimal feed rate is characterized in that the temperature of the steel bath and slag as it is supplied are kept at a constant temperature level suitable for foaming slag formation. Furthermore, it should be noted that the varying carbon quantity contained in the directly reduced iron has an effect on the foaming slag formation.

The following is furthermore to be noted with respect to FIG. 1:

The control system 1 receives from burners (not shown) at 6, 7, 8 the state variables as actual values. The control system 1 has at least two controllers 9 and 10, indicated only in a very diagrammatic manner, namely a first conventional controller 9 and a second fuzzy-logic controller 10. Depending on the algorithms stored therein, the controllers emit respective correcting variables Stₖ or St_{F} that are fed to a mediator.

The mediator 11 calculates actually outputted correcting variable St from the relation:

St=St_{K}×F+St_{F}×(1−F),

where:
St=correcting variable
St_{K}=correcting variable from the conventional controller
St_{F}=correcting variable from the fuzzy-logic controller
F=Mediator factor

To this end first the entire control process is started by a start window. A process timer is tripped that within a second initializes and starts the following subsystems and processes:
Initialization of the process manager
Read-in of the furnace configuration from XML data
Read-in of the process data (actual condition of the furnace) from SPS by an OPC server,
Read-in of the control parameters from XML files
Initialization of controller 1 (controller) and start of the control algorithms,
Sequential execution of the control algorithms,
Calculation of the correcting variables,
Writing the correcting variables in the process data,
Issue of the correcting variables to SPS by OPC server,
Display of the data on a dynamic surface (views),
Storage of the data (actual condition, correcting variables) in log files.

The subcontrollers are defined and initialized in the control system 1 (controller). Depending on the furnace configuration the subcontrollers are started according to the number of furnace elements.

If—according to embodiment of FIG. 1—for example there are three burners in a furnace, the control algorithm will be executed three times with the associated specific control parameters. The fuzzy parameters, the conventional control parameters and the mediators are defined in the control parameters (control data). As a result three different correcting variables per process variable are calculated for the three burners.

The linking of the correcting variables of conventional control engineering and fuzzy logic is carried out by the mediator 11 according to the formula above.

Furthermore, in addition to the selection between convention and fuzzy-based control engineering, the connection and disconnection of the control algorithms is possible, both as a whole, as well as specifically for an individual furnace element.

The use of fuzzy logic makes it possible to integrate the experience and specific knowledge of the process engineer and the operator of the master display into the conventional control basis.

Areas and operations of the furnace can thus be integrated into the controllers that lie outside direct measurement engineering.

The interrelationship of the control algorithms can be seen from FIG. 4.

The software is a modular, autonomous, flexible and dynamic software concept. The program is structured and developed such that easy adjustment to each furnace configuration is possible by adjustment of the furnace (furnace configuration) and control parameters (control data). The modular character makes possible easy expansion with respect to the control parameters, the furnace parameters as well as process visualization.

The autonomous architecture of the system renders possible the use in any steelworks for three-phase arc furnaces. It is connected to the steelworks by an SPS, a software-side adjustment not being necessary. This is carried out exclusively by the parameter configuration for the furnace elements and the control parameters.
The dynamic characteristic of the program makes possible
Easy adjustment of the system to a new furnace configuration,
Automatic configuration of the algorithms,
Automatic adjustment of the visualization of the process, and
Automatic adjustment of the log files
   on the basis of the previously defined furnace configuration, without software-side adjustments having to be made.

The process data is displayed according to the principles of modern, intuitive and ergonomic surface designs (GUI design). The data displays therefore conform to modern principles of surface design and incorporate the requirements of the steel workers. The object is to provide the maximum of information with the fewest possible windows and switch-over operations.

In FIGS. 2 and 3 one screen shot in each case shows the screen of the controller, one for controlling the power and one for controlling the burner (injector system burner).

The following should be noted on the structure of the system (for this see also FIGS. 4 and 5, which show diagrams of the architecture of the controller):

Process Timer/HMI Main: The start button is located on the main screen and serves to start and stop process by a timer. Furthermore, new control parameters can be transferred to the system while a process is running if adjustments to the control algorithms are necessary. Outside the main screen no other buttons are to be actuated, the process runs in the background, independent of the operator. Interventions by the operator are generally possible (HMI) from a separate surface (WiaCC surface).

Process manager: the process manager is the central control element in the system. All functions are delegated and started by the process manager. The process manager establishes the sequence of partial processes.

Controller: In the controller (control system 1) all subordinate controllers are defined and initialized. Depending on the furnace configuration, the subcontrollers are run through according to the number of furnace elements. The exception is the power control, reactor control and the control of the addition of iron (DRI control), which in the furnace occur only once.

SPS/OPC communication: This class produces the “ReadData” and “WriteData” methods for a connection to the SPS. The process data can be transmitted to the SPS and received by the SPS. The communication is carried out by an OPC server.

Process data: data that are read out from the process are stored in the objects with the identification PD (actual state, limits). Likewise the data that are transmitted to the process are temporarily stored in the objects with the identification PD (correcting variables, set).

Control data: data that are predetermined by the process engineer are stored in the objects with the identification CD (limit values, max., min., control data, fuzzy sets, use specifications of program parts). These data are inputted by the masks of the FEOS system, the operator (smelter) has no access thereto.

The developed power control system for electric-arc furnaces is thus characterized in that all of the above mentioned (and optionally also other) substance flows and energy flows are controlled by a (single) controller system. Thus a uniform user interface (HMI) is provided that gives substantial advantages in terms of operability.

In addition to the known control by operating diagrams and the classic control approaches, as a further innovation a controller based on fuzzy logic is realized for each of the correcting variables. The fuzzy logic controllers provide the electric-arc furnace expert even without further control engineering background the possibility of a quick and targeted optimization. Based on his expert knowledge, he can clearly define the linguistic variables and the associated controllers. For example, he knows how many degrees Celsius are meant by a “high cooling water temperature” and how to react to this.

The selection of the fuzzy algorithm is almost arbitrary, in general the max-prod method lends itself. Likewise the form and number of the respective sets can be adjusted to the object as desired. To achieve dynamic behavior, corresponding dynamic variables, such as the abstraction of a temperature, can be used as input variable.

The controller described offers the operator the possibility of continuously switching over by means of the weighting factor F from control to control. According to the weighting factor the correcting variable actually used is assembled from the specifications of the control and the controllers, whereby plausibility limits are maintained. This is possible since the controllers do not contain any integrative portion.

According to the invention proposed therefore the insulated individual controllers are combined to form a controller assembly. Instead of many different interfaces, only one single user interface (HMI) is provided. The realization of the controller is carried out by means of fuzzy logic. A sliding transition from a control device to a controller, e.g. also to the fuzzy logic controller is ensured through the adjustable mediators.

To this end FIG. 6 shows diagrammatically the functional description of the processes taking place in the furnace by the specification of the Level 1 system and the description by time constants (on the left side) and the specification of the fuzzy set (definition of fuzzy elements) and their degree of influence (on the right side) as well as the specification resulting therefrom of the influence parameters in the mediator (there: weighting of the influence of the different control concepts; subsequently generated desired value from the weighted mean of both control concepts). The desired values (correcting values) of the control loop in turn result from this.

FIG. 7 shows diagrammatically the incorporation of the control system (Control) of the furnace (electric-arc furnace) into an environment through which the required data for the operation of the system are provided.

### LIST OF REFERENCE NUMBERS

1 Controller
2 Electric-arc furnace
3 Vessel
4 Metal to be melted
5 Electrode
6 Burner
7 Burner
8 Burner
9 Conventional controller
10 Fuzzy controller
11 Mediator
St Correcting variable
St_{K} Conventional correcting variable
St_{F} Fuzzy correcting variable
F Mediator factor

1. A method of operating an arc furnace, during the operation of which a number of controlled operating parameters are maintained between predetermined limits by a controller system working with or without feedback, wherein the controller system has a conventional controller and a fuzzy-logic controller that feed respective correcting variables to at least one mediator that calculates the actuating signal according to a predetermined weighting factor from the correcting variables coming from the conventional controller and from the fuzzy-logic controller.

2. The method according to claim 1 wherein the controlled operating parameter is the intensity of a burner with which material is heated in the furnace.

3. The method according to claim 1 wherein the controlled operating parameter is the input power of an electric arc with which material is heated in the furnace.

4. The method according to claim 1 wherein the controlled operating parameter is the reactance of a feed line including a choke for an electric arc with which material is heated in the furnace.

5. The method according to claim 1 wherein the controlled operating parameter is the intensity of an afterburner with which material is heated in the furnace.

6. The method according to claim 1 wherein the controlled operating parameter is a parameter that correlates to a quantity of foamed slag located in the furnace.

7. The method according to claim 1 wherein the quantity of a gas supplied to a heating element of the furnace is used as a controlled operating parameter.

8. The method according to claim 1 wherein the quantity of the added iron is used as a controlled operating parameter.

9. The method according to one of claims 2 through 8,
characterized in that
at least two of the controlled operating parameters are processed in a single controller system.

10. A melt-metallurgic furnace, during the operation of which a number of controlled operating parameters are maintained between predetermined limits by means of a controller system wherein the controller system has a conventional controller and a fuzzy-logic controller that are both connected to at least one mediator that calculates an actuating signal according to a predetermined weighting factor from the correcting variables coming from the conventional controller and from the fuzzy-logic controller.

11. (canceled)

12. The furnace according to claim 10 wherein a separate mediator can be assigned to each controlled operating parameter.
